(19) United States
(12) Patent Application Publication
(10) Pub. No.: US 2024/0003252 A1
(43) Pub. Date: Jan. 4, 2024

(54) CONTINUOUS MINING AND DELAYED FILLING MINING METHOD FOR DEEP ORE BODY MASONRY STRUCTURE

(71) Applicant: Shandong Gold Mining Co., Ltd., Jinan City (CN)

(72) Inventors: Mingde Zhu, Jinan City (CN); Zaitao Liu, Jinan City (CN); Chao Peng, Jinan City (CN); Huanxin Liu, Jinan City (CN); Yingjie Hao, Jinan City (CN); Kuikui Hou, Jinan City (CN); Yantian Yin, Jinan City (CN); Zhihai An, Jinan City (CN); Haoqin Zhang, Jinan City (CN); Guilin Li, Jinan City (CN); Xingquan Liu, Jinan City (CN); Zhen Liu, Jinan City (CN)

(73) Assignee: Shandong Gold Mining Co., Ltd., Jinan City (CN)

(21) Appl. No.: 17/897,788

(22) Filed: Aug. 29, 2022

(30) Foreign Application Priority Data
Jul. 4, 2022 (CN) 202210779994.6

(51) Int. Cl. E21C 41/22; B65G 43/00; E21F 13/02; E21F 15/00

(52) U.S. Cl. CPC E21C 41/22; B65G 43/00; E21F 13/02; E21F 15/005; B65G 15/24

(57) ABSTRACT

A continuous mining and delayed filling mining method for a deep ore body masonry structure is provided, comprising: dividing an ore body into ore blocks along a trend, internally dividing each ore block into stopes with square masonry structures, and reserving a rib pillar between the ore blocks; arranging an ore block conveyor belt gallery and a stope conveyor belt gallery at the lower parts of the ore blocks, arranging ore block crossheading and stope crossheading at the upper parts of the ore blocks, mining the stopes in the sequence from the foot wall to the hanging wall. In accordance with the present disclosure, adverse effects caused by deep high geo-stress and high geo-temperature on mining operation can be effectively overcome. The method has the advantages of low carbon and environmental protection, safety of recovery operation, high mechanization of stope operation, low labor intensity of manual operation and the like.

### CROSS REFERENCE TO RELATED APPLICATION

This patent application claims the benefit and priority of Chinese Patent Application No. 202210779994.6, filed on Jul. 4, 2022, the disclosure of which is incorporated by reference herein in its entirety as part of the present application.

### TECHNICAL FIELD

The present disclosure belongs to the technical field of mining, and in particular relates to a continuous mining and delayed filling mining method for a deep ore body masonry structure, which is especially suitable for the mining of steeply inclined thick ore body under a deep “three-high” condition.

### BACKGROUND ART

There are a lot of precious mineral resources in the earth's crust, but decades of continuous large-scale exploitation of resources have made the shallow mineral resources in China tend to be exhausted. In the future, the exploitation of mineral resources in our country will fully enter the deep-seated deposits within the second depth space (1,000-2,000 m), and the deep mining of metal mines will become the norm. According to incomplete statistics, hundreds of metal mines with mining depths of more than kilometers are exploited abroad at present, distributed in countries and regions such as South Africa, Canada, Australia and European Union, while in-process underground mines with the deepest mining depths in the world are mainly distributed in South Africa and Canada, 7 of the first 10 mines are all in South Africa and 2 in Canada. South Africa, Canada, India, the United States, Russia and the like are the countries with the largest deep metal mining wells in the world, the mining depth of most gold mines exceeds 2,000 m. For example, the mining depth of Mponeng gold mine in South Africa has exceeded 4,000 m (2.5 miles) at present, and the buried depth of ore body is even more than 7,500 m; the development depth of LaRonde polymetallic mine in Canada has reached 3,008 m, and the ore body extends to 3,700 m; Lucky Friday, a famous polymetallic mine with rockburst tendency in the United States, has also completed the development of 2,920 m shaft. Although the mining depth of Chinese metal mines is shallow compared with numerous deep metal mines abroad, a large batch of metal mines are in the stage of comprehensively advancing to the deep. According to statistics and prediction, there are nearly 50 metal mines will walk into the deep mining range of below 1,000 m during the 13th Five-Year Plan Period of China, nearly half of which will reach below 1,500 in the future 10-20 years. Hongtoushan copper mine, gold mine in southwestern Hunan province, JiaPiGou gold mine, Dongguashan copper mine, Fankou lead-zinc mine, Linglong gold mine, Huize lead-zinc mine, Chengchao iron mine and the like have basically entered or will enter the deep mining range of 1,000 to 2,000 m, where the Hongtoushan copper min in Liaoning province has reached 1,300 m, the Jiapigou gold mine in Jilin province has reached 1,400 m, and Linbaofuxin gold mine in Henan province has reached 1,600 m. Recently, a large gold deposit with metal reserves of 400 t has been ascertained at the depth of 1,600-2,000 m in Xiling mining area in the Sanshan island gold mine, indicating a direction for finding a larger-scale gold deposit in a similar ore-concentrated area in the deep Jiaodong peninsula in China. Meanwhile, according to statistics, the deepest mines (more than 2,000 m) in the world are mainly precious metal mines such as gold, silver and platinum.

The mines entering deep mining environments inevitably face serious challenges caused by three highs (high geo-stress, high geo-temperature, and high well depth). Firstly, the mines face the problem of high geo-stress, if the mining technology and process adaptive to the high-stress environment are not adopted, large engineering hazards are bound to occur, and large-scale production of mines may also be restrained seriously, leading to serious impact on the development of resource economy in China. A large amount of literature data showed that many metal mines encounter dynamic disasters such as high-energy-level rockburst and mining tremor, large-area goaf instability, roof fall and wall caving in deep mining, and such dynamic disasters are difficult to accurately predict and effectively prevent and control. Secondly, the temperature of the rock stratum increases along with the depth at a rate of (10 to 40) ° C./km, the high-temperature environment condition of the deep well seriously affects the labor productivity of workers, while the mining cost will be greatly increased for effective cooling. Thirdly, with the increase of the mining depth, the hoisting height of ores and various materials are remarkably increased, which greatly increases the hoisting cost and poses a threat to the safety production. This indicates that the current mining theory and technology has lagged behind the practical activities of deep underground engineering of humans, it is difficult to carry out effective and scientific guidance, and exploration and development are urgently needed. These technical problems, if not well solved, not only bring many hidden dangers to the safety production of many of mines in China about to enter deep mining, but also seriously restrict the exploitation efficiency and effectiveness of deep resources.

Therefore, in the situation where the exploitation of deep resources has become the norm, there is an urgent need to consider and study the following difficult issues: how to achieve safe, economic, efficient and clean production after entering the deep part, especially under the conditions of deep deposit burying, high rock temperature, large rockburst tendency and high mining strength. At present, the traditional shallow mining method and process are no longer fully applicable to the mining of deep ore bodies. Aiming at the technical problem in deep mining, a continuous mining and delayed filling mining method for a deep ore body masonry structure is disclosed, which can effectively overcome adverse effects caused by deep high geo-stress and high geo-temperature on mining operation and achieve safe, efficient and economical mining of deep ore bodies.

### SUMMARY

For the problems in the mining of existing gently inclined ore bodies, a continuous mining and delayed filling mining method for a deep ore body masonry structure is disclosed. The mining method comprises the following steps:

(1) ore block and stop arrangement: dividing an ore body into ore blocks along a trend, internally dividing each ore block into strips, and internally dividing each strip into stopes with square masonry structures, and reserving a rib pillar between the ore blocks;

(2) preliminary mining design arrangement and construction: horizontally constructing an ore block conveyor belt gallery in the rib pillar from a sub-level haulage roadway at the middle section to the boundary of the hanging wall of the ore body, and constructing a stope conveyor belt gallery along the trend from the ore block conveyor belt gallery so as to connect the stopes on the same strip in the trend direction; horizontally constructing ore block crossheading in the rib pillar from the sub-level haulage roadway at the upper middle section, and constructing stope crossheading from the ore block crossheading in the trend so as to connect the stopes on the same strip along the trend direction, wherein the ore blocks at both sides of the rib pillar share one ore block conveyor belt gallery and the ore block crossheading, the ore block conveyor belt gallery is in communication with the ore block crossheading through a service raise, and the ore block conveyor belt gallery communicates with an ore drop shaft; and

(3) ore block mining and filling: mining the stops in the sequence from the foot wall to the hanging wall, that is, first mining the stops in the strip close to the foot wall, and then mining the stopes in the strip close to the hanging wall, wherein the stopes in the same strip are mined in a retreating manner from the side away from the ore block conveyor belt gallery to the side of the ore block conveyor belt gallery, and stopes in the corresponding strips on both sides of the rib pillar are subjected to mining and filling in a staggered manner; during stope mining, firstly, performing full-section expanding brush on the stope crossheading in a mining stope range to form an upper operation chamber, constructing, by a raise boring machine, a slot raise at the center of the upper operation chamber to be in communication with the stop conveyor belt gallery at the lower parts of the stope, and constructing, by a down-the-hole drill, a downward medium-depth hole around the slot raise; installing an ore drawing funnel at the bottom of the slot raise, installing conveyor belts in the stope conveyor belt gallery and the ore block conveyor belt gallery, wherein a material receiving end of the conveyor belt is located on the lower part of the ore drawing funnel of the mining stope, and a discharging end of the conveyor belt is located at the ore drop shaft; filling detonator explosives into the downward medium-depth hole in the upper operation chamber of the stope; performing millisecond subsection blasting for ore breaking, drawing the caved ore onto the conveyor belt through the ore drawing funnel and conveying the caved ore to the ore drop shaft through the conveyor belt, constructing filling retaining walls at the end parts of the stope conveyor belt gallery and the stope crossheading after the blasting ore drawing of the stope is completed and filling the stope, and repeating the steps until the stopes in the ore block are completely mined and filled.

Preferably, the ore block has a length of 50 cm to 60 cm, and a width of the thickness of the ore body, the stope has a plane view size of 6 m×6 m to 10 m×10 m, and the rib pillar has a width of 8 m to 10 m.

Further, the ore drawing funnel, the conveyor belt and ore drawing equipment at the lower part of the ore drop shaft are subjected to intelligent linkage closed-loop control, are started and stopped at the same time during ore drawing of the stope.

Further, the hole bottom of the medium-length hole is arranged in an inverted cone shape by taking the bottom of the slot raise as the center;

the hole bottom gradually rises from inside to outside, and a conical funnel bottom structure is formed at the lower part of the stope after blasting.

Further, during stope filling, a filling body in a lime-sand ratio larger than or equal to 1:8 is adopted for filling.

Preferably, the hole bottom of the downward medium-depth hole is arranged in an inverted cone shape, and the conical inclined face has an inclined angle of 50° to 55°.

Beneficial Effects:

Compared with the prior art, the present disclosure has the following technical effects:

(1) Adverse effects caused by deep high geo-stress can be effectively overcome to guarantee the safety of the mining operation and the stability of the stope structure. After entering deep mining, the geo-stress is remarkably increased, the traditional stope arrangement forms and structural parameters are no longer applicable. In accordance with a brand-new deep stope arrangement form and structural parameters provided by the present disclosure, through the stope arrangement form with the square masonry structure and the selection of structural parameters of the stope with a small section, the problems of stope structure instability and frequent rockburst and the like under the deep high geo-stress condition can be effectively avoided, and the safety of mining operation is ensured.

(2) The mechanization degree of stope operation is high, the labor intensity of manual operation is low, the stope production capacity is large, and the efficiency is high. Highly mechanized mining equipment is adopted in stope mining and cutting operation, a raise boring machine is configured to construct a slot raise, and a down-hole rock drill is configured to construct a downward medium-depth hole, an ore drawing funnel at the bottom and conveyor belts are linked for ore removal, the mechanization degree is high, the continuity of all operation procedures and links is good, the stope production capacity is large, and the efficiency is high. And meanwhile, remote unmanned or intelligent mining can be realized.

(3) Underground operation is good in ventilation condition and excellent in operation environment. Belt conveying is directly used at the bottom of the stope for ore removal, thus the use of scraper ore removal commonly used at present is avoided. The scraper ore removal may generate a large amount of heat, dust or poisonous and harmful tail gas underground, leading to the further deterioration of the underground ventilation and mining operation conditions under a high geo-temperature condition in deep mining. The belt conveying ore removal adopted in the present disclosure has a heat generation function and is of great significance for improving the deep underground operation environment.

(4) The tailing is adopted to fill an underground goaf to effectively control the movement and deformation of an overlying rock stratum, thereby preventing the earth surface from generating large-scale collapse and protecting farmland villages and structures on the earth surface. Meanwhile, the adoption of the belt conveying ore removal underground can effectively reduce greenhouse gases such as carbon dioxide emitted by the scraper ore removal, and it also has certain beneficial effects for China to achieve the “30/60” double carbon goal.

The following further describes the technical solutions of the present disclosure in detail with reference to the accompanying drawings and the specific embodiment.

### BRIEF DESCRIPTION OF THE DRAWINGS

FIG. 1 is a front view of a continuous mining and delayed filling mining method for a deep ore body masonry structure in accordance with an embodiment;

FIG. 2 is a sectional view of an A-A line in the front view of a continuous mining and delayed filling mining method for a deep ore body masonry structure in accordance with an embodiment.

FIG. 3 is a sectional view of a B-B line in the front view of a continuous mining and delayed filling mining method for a deep ore body masonry structure in accordance with an embodiment.

FIG. 4 is a sectional view of a C-C line in the front view of a continuous mining and delayed filling mining method for a deep ore body masonry structure in accordance with an embodiment.

In the drawings: 1—rib pillar; 2—ore block conveyor belt gallery; 3—stope conveyor belt gallery; 4—ore block crossheading, 5—stope crossheading, 6—service raise; 7—ore drop shaft; 8—upper operation chamber; 10—downward medium-depth hole; 11—ore drawing funnel; 12—conveyor belt; 13—filling body.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

### EMBODIMENT I

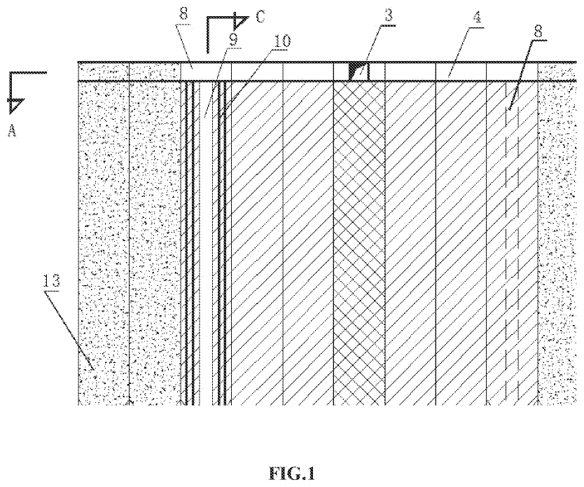

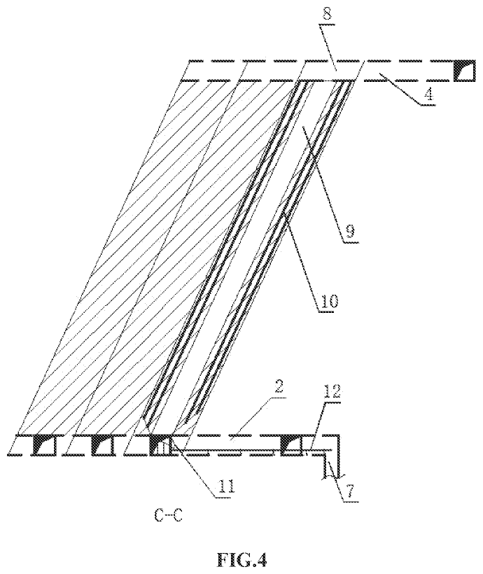

Refer to FIG. 1 to FIG. 4, a continuous mining and delayed filling mining method for a deep ore body masonry structure shown in the figures is a preferred solution of the present disclosure. The technical solution provided by the present disclosure comprises the following steps:

(1) Ore block and stop arrangement: an ore body is divided into ore blocks along a trend, each ore block having a length of 50 m and a width of the thickness of the ore body; each ore block is internally divided into strips along the trend, and each strip is internally divided into stopes with square masonry structures, each stope having a plane size of 8 m×8 m; and a rib pillar 1 is reserved between the ore blocks, the rib pillar 1 having a width of 8 m.

(2) preliminary mining design arrangement and construction: an ore block conveyor belt gallery 2 is horizontally constructed in the rib pillar 1 from a sub-level haulage roadway at the middle section to the boundary of the hanging wall of the ore body, and a stop conveyor belt gallery 3 is constructed from the ore block conveyor belt gallery 2 along the trend so as to connect the stopes on the same strip in a trend direction; ore block crossheading 4 is horizontally constructed in the rib pillar 1 from the sub-level haulage roadway at the upper middle section, and stope crossheading 5 is constructed from the ore block crossheading 4 in the trend so as to connect the stopes on the same strip in the trend direction; the ore blocks at both sides of the rib pillar 1 share one ore block conveyor belt gallery 2 and the ore block crossheading 4, the ore block conveyor belt gallery 2 is in communication with the end part ore block crossheading 4 through a service raise 6, and the ore block conveyor belt gallery 2 communicates with an ore drop shaft 7.

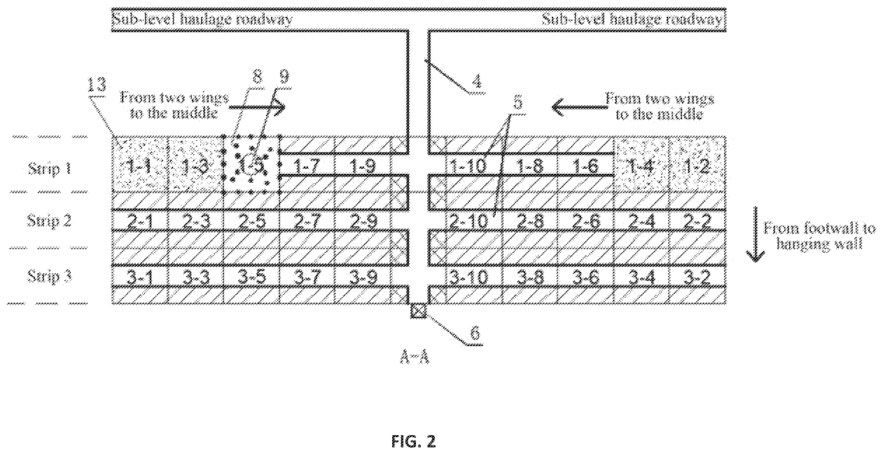

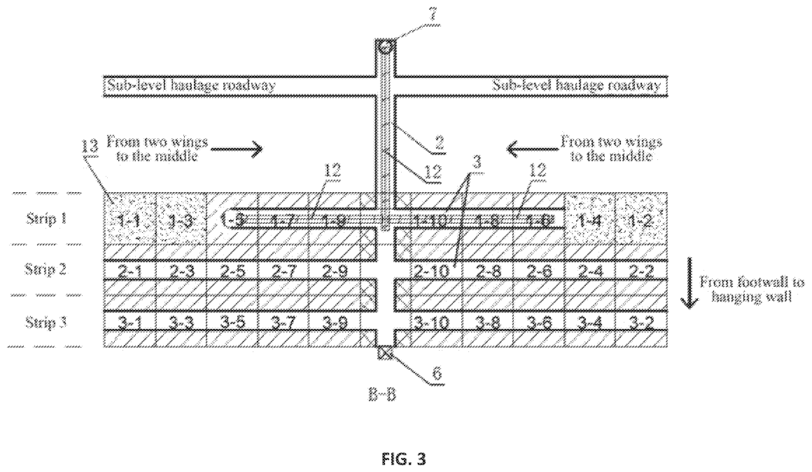

(3) Ore block mining and filling: the stops are mined in the sequence from the foot wall to the hanging wall, that is, the stops in the strip close to the foot wall are mined at first, and the stopes in the strip close to the hanging wall are mined; the stopes in the same strip are mined in a retreating manner from the side away from the ore block conveyor belt gallery 2 to the side of the ore block conveyor belt gallery 2, and the stopes in the corresponding strips on both sides of the rib pillar 1 are subjected to mining and filling in a staggered manner. As shown in FIG. 2 and FIG. 3, the stopes in the ore block are internally divided in a strip 1, a strip 2 and a strip 3. The strip 1 is internally divided into a 1-1 stope, a 1-2 stope, a 1-3 stope, a 1-4 stope, a 1-5 stope, a 1-6 stope, a 1-7 stope, a 1-8 stope, a 1-9 stope and a 1-10 stope; the strip 2 is internally divided into a 2-1 stope, a 2-2 stope, a 2-3 stope, a 2-4 stope, a 2-5 stope, a 2-6 stope, a 2-7 stope, a 2-8 stope, a 2-9 stope and a 2-10 stope; the strip 3 is internally divided into a 3-1 stope, a 3-2 stope, a 3-3 stope, a 3-4 stope, a 3-5 stope, a 3-6 stope, a 3-7 stope, a 3-8 stope, a 3-9 stope and a 3-10 stope. The mining sequence of the whole stope is as follows: the 1-1 stope, the 1-2 stope, the 1-3 stope, the 1-4 stope, the 1-5 stope, the 1-6 stope, the 1-7 stope, the 1-8 stope, the 1-9 stope, the 1-10 stope, the 2-1 stope, the 2-2 stope, the 2-3 stope, the 2-4 stope, the 2-5 stope, the 2-6 stope, the 2-7 stope, the 2-8 stope, the 2-9 stope, the 2-10 stope, the 3-1 stope, the 3-2 stope, the 3-3 stope, the 3-4 stope, the 3-5 stope, the 3-6 stope, the 3-7 stope, the 3-8 stope, the 3-9 stope and the 3-10 stope. During stope mining, firstly, the stope crossheading 5 in a mining stope range is subjected to full-section expanding brush to form an upper operation chamber 8, a raise boring machine is configured to construct a slot raise 9 at the center of the upper operation chamber 8 to be in communication with the stop conveyor belt gallery 3 at the lower part of the stope, and a down-hole drill is configured to construct a downward medium-depth hole 10 around the slot raise 9.

The hole bottom of the downward medium-depth hole 10 is arranged in an inverted cone shape by taking the hole bottom of the slot raise 9 as the center, the conical inclined face has an inclined angle of 55°, the hole bottom gradually rises from inside to outside, and a conical funnel bottom structure is formed at the lower part of the stope after blasting. An ore drawing funnel 11 is installed at the bottom of the slot raise 9, conveyor belts 12 are installed in the stope conveyor belt gallery 3 and the ore block conveyor belt gallery 2, a material receiving end of the conveyor belt 12 is located on the lower part of the ore drawing funnel 11 of the mining stope, and a discharging end of the conveyor belt 12 is located at an ore drop shaft 7; the ore drawing funnel 11, the conveyor belt 12 and ore drawing equipment at the lower part of the ore drop shaft 7 are subjected to intelligent linkage closed-loop control, are started and stopped at the same time during ore drawing of the stope. Detonator explosives are filled into the downward medium-depth hole 10 in the upper operation chamber 8 of the stope; millisecond subsection blasting is carried out for ore breaking, the caved ore are drawn onto the conveyor belt 12 through the ore drawing funnel 11 and conveyed to the ore drop shaft 7 through the conveyor belt 12, a filling retaining wall is constructed at the end parts of the stope conveyor belt gallery 3 and the stope crossheading 5 after the blasting ore-drawing of the stope is completed, and the stope is filled with a filling body 13 in a lime-sand ratio larger than or equal to 1:8. The steps are repeated until the stopes in the ore block are completely mined and filled.

### EMBODIMENT II

Refer to FIG. 1 to FIG. 4, a continuous mining and delayed filling mining method for a deep ore body masonry structure shown in the figures is a preferred solution of the present disclosure. The technical solution provided by the present disclosure comprises the following steps:

(1) Ore block and stop arrangement: an ore body is divided into ore blocks along a trend, each ore block having a length of 50 m and a width of the thickness of the ore body; each ore block is internally divided into strips along the trend, and each strip is internally divided into stopes with square masonry structures, each stope having a plane size of 8 m×8 m; and a rib pillar 1 is reserved between the ore blocks, the rib pillar 1 having a width of 10 m.

(2) Preliminary mining design arrangement and construction: an ore block conveyor belt gallery 2 is horizontally constructed in the rib pillar 1 from a sub-level haulage roadway at the middle section to the boundary of the hanging wall of the ore body, and a stop conveyor belt gallery 3 is constructed from the ore block conveyor belt gallery 2 along the trend so as to connect the stopes on the same strip in a trend direction; ore block crossheading 4 is horizontally constructed in the rib pillar 1 from the sub-level haulage roadway at the upper middle section, and stope crossheading 5 is constructed from the ore block crossheading 4 in the trend so as to connect the stopes on the same strip in the trend direction; the ore blocks at both sides of the rib pillar 1 share one ore block conveyor belt gallery and the ore block crossheading 4, the ore block conveyor belt gallery 2 is in communication with the end part of ore block crossheading 4 through a service raise 6, and the ore block conveyor belt gallery 2 communicates with an ore drop shaft 7.

(3) Ore block mining and filling: the stops are mined in the sequence from the foot wall to the hanging wall, that is, the stops in the strip close to the foot wall are mined at first, and the stopes in the strip close to the hanging wall are mined; the stopes in the same strip are mined in a retreating manner from the side away from the ore block conveyor belt gallery 2 to the side of the ore block conveyor belt gallery 2, and the stopes in the corresponding strips on both sides of the rib pillar 1 are subjected to mining and filling in a staggered manner. As shown in FIG. 2 and FIG. 3, the stopes in the ore block are internally divided in a strip 1, a strip 2 and a strip 3. The strip 1 is internally divided into a 1-1 stope, a 1-2 stope, a 1-3 stope, a 1-4 stope, a 1-5 stope, a 1-6 stope, a 1-7 stope, a 1-8 stope, a 1-9 stope and a 1-10 stope; the strip 2 is internally divided into a 2-1 stope, a 2-2 stope, a 2-3 stope, a 2-4 stope, a 2-5 stope, a 2-6 stope, a 2-7 stope, a 2-8 stope, a 2-9 stope and a 2-10 stope; the strip 3 is internally divided into a 3-1 stope, a 3-2 stope, a 3-3 stope, a 3-4 stope, a 3-5 stope, a 3-6 stope, a 3-7 stope, a 3-8 stope, a 3-9 stope and a 3-10 stope. The mining sequence of the whole stope is as follows: the 1-1 stope, the 1-2 stope, the 1-3 stope, the 1-4 stope, the 1-5 stope, the 1-6 stope, the 1-7 stope, the 1-8 stope, the 1-9 stope, the 1-10 stope, the 2-1 stope, the 2-2 stope, the 2-3 stope, the 2-4 stope, the 2-5 stope, the 2-6 stope, the 2-7 stope, the 2-8 stope, the 2-9 stope, the 2-10 stope, the 3-1 stope, the 3-2 stope, the 3-3 stope, the 3-4 stope, the 3-5 stope, the 3-6 stope, the 3-7 stope, the 3-8 stope, the 3-9 stope and the 3-10 stope. During stope mining, firstly, the stope crossheading 5 in a mining stope range is subjected to full-section expanding brush to form an upper operation chamber 8, a raise boring machine is configured to construct a slot raise 9 at the center of the upper operation chamber 8 to be in communication with the stop conveyor belt gallery 3 at the lower part of the stope, and a down-hole drill is configured to construct a downward medium-depth hole 10 around the slot raise 9.

The hole bottom of the downward medium-depth hole 10 is arranged in an inverted cone shape by taking the hole bottom of the slot raise 9 as the center, the conical inclined face has an inclined angle of 50°, the hole bottom gradually rises from inside to outside, and a conical funnel bottom structure is formed at the lower part of the stope after blasting. An ore drawing funnel 11 is installed at the bottom of the slot raise 9, conveyor belts 12 are installed in the stope conveyor belt gallery 3 and the ore block conveyor belt gallery 2, a material receiving end of the conveyor belt 12 is located on the lower part of the ore drawing funnel 11 of the mining stope, and a discharging end of the conveyor belt 12 is located at an ore drop shaft 7; the ore drawing funnel 11, the conveyor belt 12 and ore drawing equipment at the lower part of the ore drop shaft 7 are subjected to intelligent linkage closed-loop control, are started and stopped at the same time during ore drawing of the stope. Detonator explosives are filled into the downward medium-depth hole 10 in the upper operation chamber 8 of the stope; millisecond subsection blasting is carried out for ore breaking, the caved ore are drawn onto the conveyor belt 12 through the ore drawing funnel 11 and conveyed to the ore drop shaft 7 through the conveyor belt 12, a filling retaining wall is constructed at the end parts of the stope conveyor belt gallery 3 and the stope crossheading 5 after the blasting ore-drawing of the stope is completed, and the stope is filled with a filling body 13 in a lime-sand ratio larger than or equal to 1:6. The steps are repeated until the stopes in the ore block are completely mined and filled.

The foregoing descriptions are merely specific embodiments of the present disclosure, but are not intended to limit the scope of protection the present disclosure. Any variation or replacement made by a person skilled in the art according to the technical solutions of the present disclosure and its inventive concept within the technical scope disclosed in the present disclosure should be encompassed within the scope of protection of the present disclosure.

What is claimed is:

1. A continuous mining and delayed filling mining method for a deep ore body masonry structure, comprising the following steps:
(1) ore block and stop arrangement: dividing an ore body into ore blocks along a trend, internally dividing each ore block into strips, and internally dividing each strip into stopes with square masonry structures, and reserving a rib pillar between the ore blocks;
(2) preliminary mining design arrangement and construction: horizontally constructing an ore block conveyor belt gallery in the rib pillar from a sub-level haulage roadway at the middle section to the boundary of the hanging wall of the ore body, and constructing a stope conveyor belt gallery along the trend from the ore block conveyor belt gallery so as to connect the stopes on the same strip in the trend direction; horizontally constructing ore block crossheading in the rib pillar from the sub-level haulage roadway at the upper middle section, and constructing stope crossheading from the ore block crossheading in the trend so as to connect the stopes on the same strip along the trend direction, wherein the ore blocks at both sides of the rib pillar share one ore block conveyor belt gallery and the ore block crossheading, the ore block conveyor belt gallery is in communication with the end part ore block crossheading through a service raise, and the ore block conveyor belt gallery communicates with an ore drop shaft; and
(3) ore block mining and filling: mining the stops in the sequence from the foot wall to the hanging wall, that is, first mining the stops in the strip close to the foot wall, and then mining the stopes in the strip close to the hanging wall, wherein the stopes in the same strip are mined in a retreating manner from the side away from the ore block conveyor belt gallery to the side of the ore block conveyor belt gallery, and stopes in the corresponding strips on both sides of the rib pillar are subjected to mining and filling in a staggered manner; during stope mining, firstly, performing full-section expanding brush on the stope crossheading in a mining stope range to form an upper operation chamber, constructing, by a raise boring machine, a slot raise at the center of the upper operation chamber to be in communication with the stop conveyor belt gallery at the lower parts of the stope, and constructing, by a down-the-hole drill, a downward medium-depth hole around the slot raise; installing an ore drawing funnel at the bottom of the slot raise, installing conveyor belts in the stope conveyor belt gallery and the ore block conveyor belt gallery, wherein a material receiving end of the conveyor belt is located on the lower part of the ore drawing funnel of the mining stope, and a discharging end of the conveyor belt is located at the ore drop shaft; filling detonator explosives into the downward medium-depth hole in the upper operation chamber of the stope; performing millisecond subsection blasting for ore breaking, drawing the caved ore onto the conveyor belt through the ore drawing funnel and conveying the caved ore to the ore drop shaft through the conveyor belt, constructing filling retaining walls at the end parts of the stope conveyor belt gallery and the stope crossheading after the blasting ore drawing of the stope is completed and filling the stope, and repeating the steps until the stopes in the ore block are completely mined and filled.

2. The continuous mining and delayed filling mining method for the deep ore body masonry structure according to claim 1, wherein the ore block has a length of 50 m to 60 m, and a width of the thickness of the ore body, the stope has a plane size of 6 m×6 m to 10 m×10 m, and the rib pillar has a width of 8 m to 10 m.

3. The continuous mining and delayed filling mining method for the deep ore body masonry structure according to claim 1, wherein the ore drawing funnel, the conveyor belt and ore drawing equipment at the lower part of the ore drop shaft are subjected to intelligent linkage closed-loop control, are started and stopped at the same time during ore drawing of the stope.

4. The continuous mining and delayed filling mining method for the deep ore body masonry structure according to claim 1, wherein the hole bottom of the downward medium-length hole is arranged in an inverted cone shape by taking the bottom of the slot raise as the center; the hole bottom gradually rises from inside to outside, and a conical funnel bottom structure is formed at the lower part of the stope after blasting.

5. The continuous mining and delayed filling mining method for the deep ore body masonry structure according to claim 1, wherein during stope filling, a filling body in a lime-sand ratio larger than or equal to 1:8 is adopted for filling.

6. The continuous mining and delayed filling mining method for the deep ore body masonry structure according to claim 4, wherein the hole bottom of the downward medium-depth hole is arranged in an inverted cone shape, and the conical inclined face has an inclined angle of 50° to 55°.
